(19) United States
(12) Patent Application Publication
(10) Pub. No.: US 2026/0029834 A1
(43) Pub. Date: Jan. 29, 2026

(54) DISPLAY MODE CONTROL FOR MOBILE COMPUTING DEVICES

(71) Applicant: Uber Technologies, Inc., San Francisco, CA (US)

(72) Inventors: Lakshmi Ashok, San Francisco, CA (US); Yingxing Lin, San Francisco, CA (US); Zhaolei Shi, San Francisco, CA (US); Diana Alyssa Zmuda, San Francisco, CA (US)

(21) Appl. No.: 19/279,842

(22) Filed: Jul. 24, 2025

Related U.S. Application Data
(60) Provisional application No. 63/675,591, filed on Jul. 25, 2024.

(51) Int. Cl. G06F 1/3234; G06F 1/28; G06F 1/3209; G06F 1/3212

(52) U.S. Cl. CPC G06F 1/3265; G06F 1/28; G06F 1/3209; G06F 1/3212

(57) ABSTRACT

A service application operates on a mobile computing device of a user to determine a battery state. Based on the determined battery state, a first display mode is implemented in which a display output is configured to reduce energy. When the first display mode is implemented, the service application can respond to a time-limited network event by automatically switching to a regular display mode for a time interval during which content of the time-limited network event is displayed. The service application can automatically switch back to the low-energy display after a duration that coincides or is based on the time interval.

### RELATED APPLICATIONS

This application claims benefit of priority to provisional U.S. Patent Application 63/675,591, filed Jul. 25, 2024; the aforementioned priority application being hereby incorporated by reference in its entirety.

### TECHNICAL FIELD

Examples include a multi-mode user interface for a mobile application.

### BACKGROUND

Increasingly, there are many applications where mobile computing devices are critical resources for a user. For example, in the context of on-demand transportation services, service providers typically utilize their mobile computing devices to receive important service information, receive and communicate job orders, and to navigate to service locations. The use of mobile devices in such context can be continuous for long durations of time and intensive.

### BRIEF DESCRIPTION OF DRAWINGS

FIG. 1 illustrates a service application operating on a mobile computing device to implement display mode control, according to one or more embodiments.

FIG. 2 illustrates an example method for implementing a low-energy display mode on a mobile computing device of a user, according to one or more embodiments.

FIG. 3 illustrates an example method for enabling a mobile computing device to utilize a network service, in conjunction with a service application operating on the mobile computing device controlling a display mode, according to one or more embodiments.

FIG. 4 is a block diagram illustrating an example user device on which a service application can be operated, according to one or more embodiments.

FIG. 5 is a block diagram that illustrates a network computer system, according to one or more embodiments.

### DETAILED DESCRIPTION

According to examples herein, a service application operates on a mobile computing device of a user to determine a battery state. Based on the determined battery state, a first display mode is implemented in which a display output is configured to reduce the consumption of energy. When the first display mode is implemented, the service application can respond to a time-limited network event by automatically switching to a regular or default display mode (or a mode in which a higher amount of energy is consumed than the first display mode) for a time interval during which content of the time-limited network event is displayed. The service application can automatically switch back to the low-energy display mode after a duration that coincides or is based on the time interval.

According to examples, a service application operates on a mobile computing device of a user to determine a battery state. Based on the determined battery state, the service application causes a first display mode to be implemented on the mobile computing device (e.g., a dimmer display as compared to the brightness level when the device is in a regular or default mode). Upon the service application being triggered to display a content that is based on a communication received from a network service, the service application causes a first mode switch in which a second display mode is implemented on the mobile computing device. This second display mode causes the mobile computing device to expend more energy than the first display mode. The mobile computing device causes a second mode switch in which a third display mode is implemented. This third display mode causes the mobile computing device to expend less energy than the second display mode, where the third display mode coincides with the service application ceasing to display the content of the communication.

In some examples, the third display mode is the same, or about the same, as the first display mode. Thus, for example, the second mode switch causes the mobile computing device to revert back to the prior mode. As used with examples, the term “about” is intended to mean that a comparison of two states or measurements are at least 90% of one another. For example, the brightness level of the first display mode may be between 90-100% of the third display mode.

Among other advantages and technical benefits, examples enable a service provider to prolong the battery life of their mobile device, by changing a display mode for a display output of an application executing on a mobile computing device before the charge level of the battery becomes critical. In particular, a service application executing on a mobile device can implement a configuration in which a display output varies between one or more dimmed states and a default (or bright state), based on events (such as receiving a time-limited network communication). In at least some examples, the service application varies its display output separate from the operating system and its settings. Additionally, in examples, when important, time-sensitive or time-limited information is communicated to the user, the display output can be automatically switched to a regular display mode. In this way, the display output is not diminished (e.g., dimmed) at times when the user is likely viewing important information on the user device.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Moreover, examples described herein can generally require the use of specialized computing devices, including processing and memory resources. For example, one or more examples described may be implemented, in whole or in part, on computing devices such as servers, desktop computers, cellular or smartphones, laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and configured to execute the program corresponds to a special-purpose computing device. Furthermore, any computing systems referred to in the specification may include a single processor or may be architectures employing multiple processor designs for increased computing capability.

Still further, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile computing devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

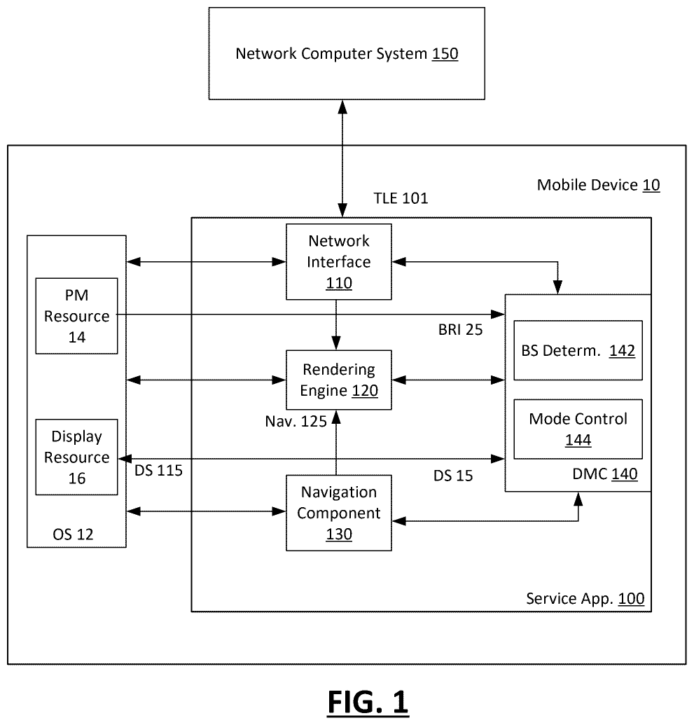

FIG. 1 illustrates a service application operating on a mobile computing device to implement display mode control, according to one or more embodiments. In examples, a service application 100 operates on a mobile computing device 10 of a user to enable various functionality. In at least some examples, the service application 100 operates to enable a user of the mobile computing device 10 to communicate with, and to participate in a network service provided by a network computer system 150.

The service application 100 includes and/or executes processes represented by a network interface 110, a rendering engine 120, a navigation component 130, and a display mode component 140. The rendering engine 120 can include processes that utilize a variety of inputs in generating a display content that includes application content, where the application content includes a functional, interactive user interface, to enable the user to respond to, for example, time-limited or temporal communications of a network service. In some examples in which the service application 100 enables the user to participate in a network service as a service provider, the rendering engine 120 provides an interactive interface that enables the user to view information, such as his or her profile, schedule, recent history, earnings and the like. The user can elect to go online, meaning the service provider initiates a session where the user is available as a service provider to provide transport or delivery services. The network computer system 150 communicates with the service application 100 to confirm, and further enables functionality of the service application, including functionality described with the display mode component 140. The rendering engine 120 can then render content received from the network computer system 150 via the network interface 110. For example, the rendering engine 120 can render notifications or alerts, where opportunities (e.g., job orders to fulfill service requests) are communicated from the network computer system 150. Further, the rendering engine 120 can display mapping and navigation content, as described in additional examples.

In examples, the display mode component 140 controls implementation of a display mode on the mobile computing device 10. In some examples, the display mode component 140 is implemented as a feature of a service application 100, when the service application 100 is operating on the mobile computing device 10. While examples are described which provide for the display mode component 140 to function as part of a service application 100, in variations, the display mode component 140 can be implemented as a program or process that is separate from a service application. For example, the display mode component 140 can be implemented as a set of instructions and/or communicated from a network computer system 150.

During the service provider's session, the processes represented by the network interface 110 communicate with the network computer system 150 to receive network service information, including time-limited events. The network interface 110 can include notifications, messages and other communications that include various types of network service information, such as information about opportunities or time-limited events.

With further reference to FIG. 1, the display mode component 140 includes battery state determination 142, and mode control 144. The battery state determination 142 represents processes that determine a battery state of the mobile computing device 10. The battery state can reflect a power level of the mobile device's batteries, as well as the presence or impact of factors that impact the ability of the batteries to receive or preserve charge. As described with examples, these factors can include the presence of a power input (e.g., cable charger is plugged in or through inductive proximity), the quality or level of charge being received, and/or the display settings of the application or device. The mode control 144 represents processes for selecting a display output mode based on the determination of the battery state.

### Battery State Determination

The battery state determination 142 can apply rules, heuristics, models and other logic (e.g., predictive models) to determine a battery state of the mobile computing device 10. In examples, the battery state can correspond to a value, or set of values (e.g., a range of values) that is indicative of the power resources that are currently available to the mobile computing device 10. In examples, the battery state can indicate whether (i) a charge level of the mobile computing device's battery is less than a threshold level, and/or (ii) the battery is currently being charged or is connected to an external power source. As an addition or variation, the battery state can indicate whether a set of predetermined conditions exist which are deemed to either conserve or deplete energy, relative to a baseline reference or assumption. Still further, in some examples, the battery state indicates whether the mobile computing device 10 has sufficient power resources to remain operational during an upcoming time interval, to enable a designated set of functionalities (e.g., core functionality) with respect to the service application 100. As described with examples, the determination can be based on a variety of inputs or determinations.

In examples, the battery state can be based at least in part on or otherwise reflect the existence of one or more conditions that affect a battery life of the mobile computing device 10. For example, the battery state can be based at least in part on, or reflect, a condition where the battery is deemed to not be charging, and/or a condition in which the battery level of the mobile computing device is or is/not diminishing. The battery state determination 142 can query power management resources 14 of the operating system 12 to determine a current charge level of the battery, as well as other battery-related information 25 such as whether the mobile computing device is currently being charged (e.g., mobile computing device 10 is receiving charge from a cable or inductive charging port).

In additional examples, the battery state determination 142 determines the battery state based at least in part on the existence of one or more conditions that affect a power consumption of the mobile computing device 10 over an upcoming time interval. In an example, the battery state determination 142 can determine a display setting used with the service application 100 or by the operating system 12 of the mobile computing device 10. The battery state determination 142 can determine the battery state based at least in part on the setting used with the service application 100, where for example, the setting reflects that the display output of the rendering engine 120 is in a dark mode (or “night mode”).

As an addition or variation, the battery state determination 142 can determine the battery state based at least in part on information about an activity of a connected computing device. In examples, the battery state can be determined based at least in part on a determination that a vehicle's computer (e.g., on-board computing system of the vehicle that is coupled to a display of the vehicle) is being used to perform operations that would otherwise be performed by the service application 100. The battery state determination 142 can make the determination by retrieving information about the connectivity status of the mobile computing device 10 from the operating system 12. The connectivity status can, for example, indicate the mobile computing device 10 is wirelessly connected to a computer system of the user's vehicle. Additionally, the service application 100 or operating system 12 can determine the activity that is being performed by the connected computer of the vehicle. For example, the operating system 12 can determine that the vehicle computer is displaying navigation content, meaning the mobile computing device 10 is not being used to perform the navigation.

In examples, the battery state includes a parametric value that reflects a determination of whether an intervention is warranted to conserve the battery life of the mobile computing device 10. The parametric value can be binary (e.g., true/false), where the value of the battery state reflects whether or not a predefined “low battery life condition” exists. Depending on implementation, the term “low battery life” condition can reflect a condition where the battery life of the mobile computing device is, or will likely be during an upcoming time interval (e.g., next 4 hours, etc.), below a designated threshold. In variations, the battery state can correspond to a parametric value that includes multiple possible values to represent alternative “low battery life” conditions. For example, the possible values of the battery state can include (i) a first value that reflects the mobile computing device 10 is currently in a low battery life condition (e.g., battery level is below a first threshold value, and no external power is being received); (ii) a second value that reflects the mobile computing device is in a second low battery level condition (e.g., battery level is below a second threshold value and/or no external power is charging the battery); and (iii) a third value that reflects the mobile computing device is not in a low battery level condition (e.g., battery level is above a third threshold value and/or battery is being charged, etc.).

While the low battery life condition can reflect a current charge level of the battery, in some implementations, the determination of the low battery life condition can be based on other factors other than the current charge level of the battery. For example, a low battery life condition can be determined to exist when the battery is not being charged. Likewise, in other implementations, even if the current charge level of the battery is deemed to be low (e.g., below a designated low threshold level), the battery state can correspond to a determination that no low battery life condition exists when, for example, the battery is being charged by an external source. Thus, the determination of the battery state can be based on implementation. Further, the determination can include the use of logic that includes rules, heuristics and/or models, that are executed by or through the service application 100. By way of example, any of the following set of rules, or combinations thereof, can be used to determine the battery state:
1) no external charge is being received;
2) current charge level of battery is below a first low battery charge threshold;
3) current charge level of battery is below a second low battery charge threshold (which may or may not be the same as the first low battery charge threshold) AND no external charge is being received;
4) current charge level of battery is below a first low battery charge threshold and no external charge is being received, OR current charge level of battery is below a second low battery charge threshold that is less than the first low battery charge threshold while external charge is being received;
5) where the service application is running in the foreground; and/or
6) whether “dark mode” is selected for the service application or operating system.

Various other factors can weight, influence or be determinative of the battery state. For example, the battery state determination 142 can determine whether any predefined battery conserving conditions are currently in use by the service application 100. The battery conserving conditions can include the service application 100 being operated in dark mode, or a vehicle computer being connected to perform a function that would otherwise be performed by the mobile computing device 10 or service application 100 (e.g., navigation). In examples, the battery state determination 142 can determine the battery state based at least in part on a determination that one or more of the battery conserving conditions are present. For example, the battery state determination 142 can determine a low battery threshold based at least in part on the presence of a battery life conserving condition.

### Display Mode Control

The mode control 144 implements any one of multiple display modes for a display output of the mobile computing device 10, where the selection of the display mode is based on the determination of the battery state. In some examples, the display mode is implemented for the display output of the service application 100, such that implementation of the display mode affects the rendering of the application content generated by the service application, without affecting the display output of the mobile computing device 10. In variations, the display mode is implemented for the display output of the mobile computing device 10, as may be implemented through the operating system 12, such that the display output affects the application screens (e.g., home screen) and the display output generated by various applications (including the service application 100) that may be operating on the device at a particular time.

In examples, each of the multiple possible display modes corresponds to a particular display output configuration, where each display output configuration is associated with a level of energy consumption by the mobile computing device 10, and where at least one of the multiple display modes is associated with a low battery life condition. For example, the display modes that are implemented on the mobile computing device can include a low-energy display mode for when a low battery life condition is determined, and a regular display mode for when no low battery life condition is determined to exist. In some examples, each of the multiple display output configurations corresponds to a level of brightness of the display output. In such examples, when the device is determined to be in the low battery life condition, the mode control 144 implements a first (low-energy) display mode, to cause the rendering engine 120 to generate a display output that is dimmed, relative to the brightness level of the normal battery life condition. By lowering the brightness level even by a fraction (e.g., 10-20%), the battery life of the mobile computing device can be extended significantly, particularly in the case where the service application is on and continuously used for several hours at a time.

In variations, the mode control 144 retrieves and implements the first display mode by communicating a value for a display setting 115 to the operating system 12, which in turn adjusts a display output setting (e.g., brightness level of device).

As an addition or variation, each display mode implemented by the mode control 144 can correspond to a different refresh rate. For example, to implement a first display mode, the mode control 144 can instruct the operating system 12 to implement a first refresh rate for the display output. Similarly, to implement a second display mode, the mode control 144 can instruct the operating system 12 to implement a second refresh rate, where the second refresh rate is greater than the first refresh rate. In this way, the mode control 144 can provide for a low battery life condition by implementing a first display mode where the refresh mode is reduced as compared to a second or regular display mode. By reducing the refresh rate, the energy consumption of the mobile computing device 10 can be reduced.

As an addition or variation, the mode control 144 can implement a first display mode for a low battery life condition by darkening some or all of the pixel values generated with the display output. When the low battery life condition is detected, the mode control 144 can instruct the rendering engine 120 and/or the operating system 12 to implement operations that darken pixel values, where the darkened pixel values are known to reduce power consumption for generating the display output.

As still another addition or variation, the display mode for the low battery life condition can correspond to the display output being in a monochromatic state. The regular display mode can correspond to a colorized state. In such examples, the monochromatic state utilizes less power than the color state, and by implementing a display mode where the display output is monochromatic, the battery life of the mobile computing device 10 is conserved.

In examples, the display mode component 140 is initiated in response to a designated network-based event. In this way, the service application 100 is enabled to control a display mode of a display output of the mobile computing device only when a network-based event is detected. In examples, the network-based event can correspond to the service application 100 requesting use of a network service provided by the network computer system 150, and the network computer system 150 confirming or otherwise enabling use of the network service by the mobile computing device 10. Absent an occurrence of the network-based event, examples provide that the service application 100 is not operable to implement alternative display modes, even when the service application 100 is operable for some tasks. In such examples, the service application 100 is prevented from, for example, implementing a low-energy display mode unless the mobile computing device 10 is being used in connection with a service provided by the network computer system 150.

In some examples, the network-based event can correspond to a designated communication from the network computer system 150. For example, the designated communication can include a response to a request, generated by or through the service application 100, to register the user as a participant of the network service. The response from the network computer system 150 can include an acknowledgment, meaning the user is permitted to participate as a service provider for a given time interval. Once the network-based event occurs, the display mode component 140 performs operations for determining the battery state of the mobile computing device 10, and further to control the display mode of the service application 100 and/or the mobile computing device (e.g., via the operating system 12).

As discussed with examples, when the display mode component 140 is initiated, processes represented by the battery state determination 142 determine a battery state of the mobile computing device 10, and processes represented by the mode control 144 control a display mode of a display output based in part on the determined battery state. The battery state determination 142 determines the battery state by determining multiple battery or power related conditions of the device. These conditions can include (i) a current battery level of the mobile computing device 10; (ii) a determination as to whether a battery of the mobile computing device 10 is receiving external power (e.g., by connected cable or power source) or is being charged; (iii) a determination of the device's current display mode; and/or (iv) a determination of whether the mobile computing device 10 is utilizing another computer (e.g., the vehicles computer) to offload functionality that would otherwise be performed through the service application 100. Additionally, in some examples, the conditions for determining the battery state of the mobile computing device 10 can include user or device specific information, such as an expected duration during which the service application 100 is to be in active use (e.g., such as a duration in which a user intends to be available as a service provider for a network service of the network computer system 150), as well as information about the battery life capacity of the mobile computing device 10 (e.g., mobile computing device 10 is unable to sustained charge because of damage or age).

When the display mode component 140 is initiated, examples provide that the mode control 144 implements processes to control a display mode for a display output of the mobile computing device 10. In examples, when the battery state indicates that the low battery state condition does not currently exist, the mode control 144 does not change the current display mode. In such case, the display output of the rendering engine 120 can be based on, for example, the display settings 15 of the operating system 12. The mode control 144 can continue to repeatedly check for the battery state of the mobile computing device 10 while the service application 100 is running or is active on the mobile computing device 10.

When the mode control 144 determines that the battery state indicates that a low battery life condition does exist on the mobile computing device 10, the mode control 144 implements a low-energy display mode to conserve power consumption of the mobile computing device 10. In examples, when the low-energy display mode is implemented, the regular display mode is switched to a low-energy display mode. As described with some examples, the mode switch may include dimming of the brightness level of the display output (e.g., by reducing screen brightness to 30% or 50%, from default brightness level), darkening of the application content generated by the rendering engine 120 either fully (e.g., “dark mode”) or partially, reducing the refresh rate for the application content and or device as a whole (via instruction to the operating system 12), or switching the display output to monochrome from color, via a display or setting of the rendering engine 120 and/or the operating system 12.

In examples, while the low battery life condition is present, the mode control 144 controls the display mode, by automatically implementing switches in the current display mode in response to one or more pre-determined events or conditions. Based on implementation, the predetermined events or conditions can include the mobile computing device 10 receiving one or more communications regarding a time-limited network event. In examples, the communications of the network computer system 150 coincides, or otherwise represents, one or more time-limited events. The communications from the network computer system 150 can include time-sensitive information that is subject to expiration after a designated time interval. For example, the communications may represent one or more service opportunities for the user of the mobile computing device 10, where each opportunity allows for user input or action that is provided within a set time interval (e.g., accept or decline, or let lapse after the time interval). The rendering engine 120 renders one or more notification(s) or alert(s) for corresponding time-limited, network-based event(s) or condition(s). The notification(s) or alert(s) can cause a user interaction, such as to cause the user to view and interact with the notification or alert. In some examples, the network interface 110 receives communications from the network computer system 150, relating to time-limited network events. For example, the time-limited events can correspond to opportunities that are made available to the user in connection with, for example, the user participating in a network service.

When a time-limited notification or alert is generated while a low power mode is being implemented, the mode control 144 automatically implements a mode switch, to cause a display output to be switched from the low-energy display mode to the regular display mode. This can result in the display output becoming brighter, less dark, having a higher refresh order, being displayed in color or implementing other such configurations.

In examples, each notification or alert that is generated in response to a corresponding time-limited event is temporal, meaning the notification or alert is active for a period of time, then responsive to the passage of time or some other event, the notification or alert is dismissed or otherwise becomes dormant. In some variations, the notifications or alerts can be associated with a timer, where the timer designates a time interval during which a notification or alert is valid. The timer can be implemented as a countdown timer by, for example, the rendering engine 120. Alternatively, a timer can be communicated by logic communicated from the network computer system 150. Still further, in some examples, the network computer system 150 can communicate a first set of communications to cause the rendering engine 120 to generate one or more notification(s) or alert(s), and upon an expiration event (e.g., passage of a designated time interval), the network computer system 150 communicates a second set of communications. In response to receiving the second set of communications, the rendering engine 120 can recognize the corresponding notification(s) or alert(s) have expired. During the time interval, the rendering engine 120 renders the notification(s) or alert(s). Upon the expiration of the time interval, the rendering engine 120 may cease rendering of the notification(s) or alert(s), by for example, dismissing, suppressing, removing or deleting the notifications/alerts.

In examples, the rendering of the notification(s) or alert(s) can coincide with a mode switch. While a low-energy display mode is being implemented, the mode control 144 can include processes that monitor for or otherwise detect the network communications and/or the rendering of the notification(s) or alert(s). In response to the network communications and/or the rendering of the notification(s) or alert(s), the mode control 144 implements a mode switch in which the mobile computing device 10 is automatically switched from a first low-energy display mode to a regular energy display mode. Thus, for example, the rendering of the notification(s) or alert(s) can be accompanied by a display output of the mobile computing device 10 being brightened, or other visual change to the display output resulting from the display mode being switched from the low-energy regular display mode (e.g., lightened pixels, higher refresh rate, colorized content etc.).

In some examples, the alternative display modes can be characterized by, or otherwise include, a variation in the refresh rate of specific types of content. For example, in a low-energy display mode, the refresh rate of map content, such as may be displayed with navigation content, can be varied. The refresh rate for the map content can be varied between, for example, a low refresh rate (e.g., 10 times per second, once per second, etc.) to a default refresh rate (e.g., 60-70 times per second).

As an addition or variation, the alternative display modes can vary in terms of the added graphics, richness, or network activity performed with respect to retrieving and rendering content. For example, in the low-energy mode, feature such as animation or graphic feedback can be eliminated or reduced. Likewise, in the context of rendering map content, the frequency in which the computing device renders or retrieves network content can be reduced when the device operates in the low-energy display mode.

Further, in some examples, the mode control 144 can automatically implement a second mode switch, to switch from the regular energy display mode to a second low-energy mode. The second low-energy display mode can be the same as the first low-energy display mode. Alternatively, the second low-energy display mode can be different than the first low-energy mode. For example, the second low-energy display mode can cause the mobile computing device 10 to expend either more or less energy than the first low-energy display mode, while expending less energy than the regular energy display mode. The mode control 144 can automatically implement the second mode switch in response to the occurrence of an event or condition, such as the passage of time or the expiration of the notification(s) or alert(s). In some examples, the mode control 144 implements the second mode switch for a duration that substantially matches a time interval associated with the time interval during which the notifications or alerts or being actively rendered by the rendering engine 120. In this way, the service application 100 controls the performance of the mobile computing device 10, by automatically switching the mobile computing device 10 out of the low-energy display mode during a limited time interval when the user is most likely viewing the notifications or alerts of the network computer system 150.

### Transport Service Examples

In examples, the network communications identify job orders that provide an opportunity for the user to provide a type of transport service. Each communication can identify information about a job order, including one or more service locations (e.g., pickup location, destination location, etc.). In examples, the network computer system 150 performs a matching process to match the user of the mobile computing device 10 with one or more job orders, based at least in part on a current location of the service provider. The matching process can be performed repeatedly, such as every X seconds (e.g., 60 seconds). Upon completion of the matching process, each job order that is matched to the service provider is transmitted at once, or during a designated matching interval (e.g., 5 seconds), to the mobile computing device 10. Each job order communicated to the mobile computing device 10 may be associated with a timer (e.g., countdown timer) that defines a period of validity for the job order. The period of validity can be set to expire, for example, some time before the start of the next matching interval.

On the mobile computing device 10, the network interface 110 can receive the communications from the network computer system 150, and in response, the rendering engine 120 can render content items representing each matched job order. When rendered, the content item for each job order can be rendered in the form of an interactive visual construct (e.g., card, list entry, panel, etc.) that can receive a user input, such as user input signifying the user's acceptance or interest individual job orders. In examples, each of the content items can be associated with a timer (e.g., countdown timer), after which the job order of the content item is expired or no longer valid. Once the job order is expired, the rendering engine 120 ceases rendering of the corresponding content. In some implementations, a user's interaction with an individual content item can cause the content item to be dismissed (e.g., removed, hidden, subject to a state change). In examples, the timer can be implemented by logic executed on the mobile computing device 10. As an addition or variation, the timer can be implemented by instructions or other logic communicated from the network computer system 150.

In examples, different types of job orders can be communicated from the network computer system 150. Further, each type of job order can be associated with a different timer, where each timer initiates at a different time and/or for a different duration. For example, the communications from the network computer system 150 can include multiple non-exclusive job orders, where each non-exclusive job order is communicated to computing devices of multiple service providers at one time.

In addition to communications about job orders, the network computer system 150 can communicate network service information 101 that includes location- or region-specific information to facilitate the service provider (e.g., traffic, market conditions, etc.), and various other types of information.

Additionally, the service application 100 can include, or access (e.g., as a third-party application), a navigational component 130. The navigational component 130 can include processes that obtain a current location of the service provider from a location-aware resource (e.g., GPS component or other type of satellite receiver) of the mobile computing device 10. The navigational component 130 can use the current location to route or guide the service provider to a location, such as a service location of a job order. The navigational component 130 can also access a mapping resource to obtain map-related data, where the mapping resource can correspond to an internal or external resource. The navigational component 130 can use the current location and the map-related data to generate navigation data 125 for the user, where the navigation data 125 identifies a route for the user to take (e.g., from a current location of the mobile computing device 10 to a target service location). Based on the navigation data 125, the rendering engine 120 can render navigation and mapping content using routing/mapping output of the navigation component 130.

In examples, the mode control 144 determines, based on the navigation data 125, when the user approaches a service location. For example, the mode control 144 can detect when the service provider has registered for a session with a network service of the network computer system, and subsequently when the service provider operates a vehicle to drive to a service location (e.g., pickup or destination location for a transport request). When a low-energy display mode is being implemented, and the user reaches a threshold driving distance from the service location (e.g., 0.1 miles), the mode control 144 can implement a mode switch, to switch the mobile computing device from a low-energy display mode to a regular energy display mode.

### Methodology

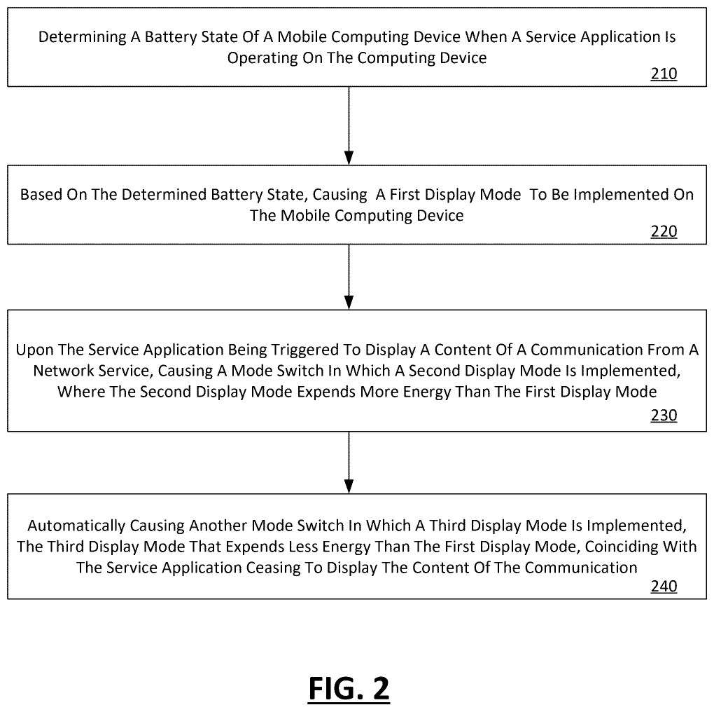

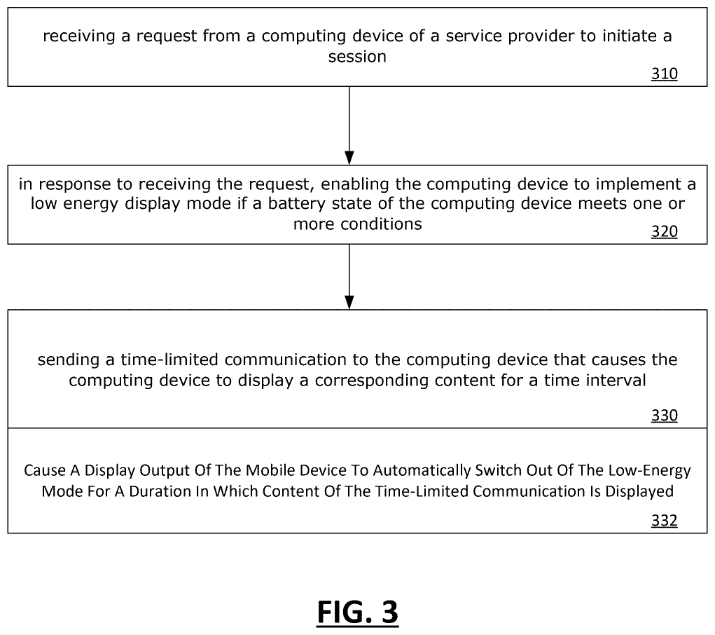

FIG. 2 illustrates an example method for implementing a low-energy display mode on a mobile computing device of a user, according to one or more embodiments. FIG. 3 illustrates an example method for enabling a mobile computing device to utilize a network service, in conjunction with a service application operating on the mobile computing device controlling a display mode, according to one or more embodiments. In describing examples of FIG. 2 or FIG. 3, reference may be made to elements of FIG. 1 for purpose of illustrating suitable functionality for performing a step or sub-step being described.

In step 210, a service application operates to determine a battery state of the computing device. As described with examples, the battery state is an indicator of power resources (e.g., battery, external power, etc.) available to the mobile computing device 10. In examples, the battery state can indicate that a charge level of the mobile computing device's battery is below a low charge threshold, and further that the mobile computing device's battery is not being charged. The battery state can also indicate whether one or more predetermined conditions that affect a battery life of the mobile computing device 10 exist. As an example, the battery state can indicate a condition in which the service application 100 or mobile computing device 10 is operating in a dark mode, as dark mode is likely to conserve power. As another example, the battery state can indicate a condition in which another computing device is being used perform a function that would otherwise be performed by the service application 100. For example, the battery state can indicate a determination that a vehicle computer (different from the mobile computing device 10) is being used for navigation. In such case, the user is likely to rely on the vehicle computer for navigation, rather than the service application 100.

In examples, the service application 100 can query the operating system 12 of the mobile computing device 10 to obtain information for making its determination of the battery state. For example, the service application 100 can query a display resource 16 of the operating system 12 for a current charge level of the battery, a charging or connectivity status of the battery indicating whether or not the battery is being charged, a display setting of the mobile computing device 10, and/or information about the activity of a connected device (e.g., vehicle computer being used for navigation).

The battery state can include a parametric value that reflects whether a predefined low battery life condition exists on the mobile computing device 10. The battery state can include parametric values that reflects whether any one of multiple predefined low battery conditions exist on the mobile computing device 10. The determination of the battery state can be based on logic that includes rules, heuristics and or models.

Based on the determined battery state, in step 220, the service application 100 operates to cause a first display mode to be implemented on the mobile computing device. The first display mode can correspond to a low-energy display mode, reflecting a configuration or setting of a display output where the configuration/setting expends less energy than a regular display mode. In some examples, low-energy display mode can be implemented for a display output of the service application 100. For example, the low-energy display mode can be implemented by dimming a brightness level of the display output generated by the service application 100.

In variations, the low-energy display mode can be implemented for a display output of the mobile computing device 10. In such examples, the service application 100 can communicate a change to a display setting 115 or configuration to an operating system 12 of the mobile computing device 10, to cause a change in a display setting or configuration of the mobile computing device. For example, the service application 100 can communicate to the operating system a setting for the brightness level for the display output for the mobile computing device 10, where the setting lowers the brightness level so that the display output is dimmed. In variations, other settings are configurations can be used to implement a low-energy display mode for displaying output of the mobile computing device 10. For example, a low-energy display mode can be implemented by darkening the display output, lowering a refresh rate for the display output, implementing monochromatic versus colorize display output, and the like.

Further, as described, the implementation of the low-energy mode can result from a mode switch, where the low-energy display mode is implemented in place of a second display mode. The second display mode can refer to a regular display mode, such as coinciding with a configuration or setting of the operating system 12 before the low-energy display mode is implemented. By way of illustration, before the service application 100 is opened, the display output of the mobile computing device 10 may have a current configuration or setting DS 15, reflecting, for example, a current brightness level. Once the service application 100 is running on the mobile computing device 10, the service application 100 determines the battery state. Based on the battery state, the service application 100 makes a determination as to whether the low-energy display mode is to be implemented. If the determination is to not implement the low-energy display mode, then the service application 100 makes no change to the current configuration or setting of the display mode. Thus, for example, the display output of the service application 100 may match the configuration or setting uses by the operating system 12. Conversely, if the determination is to implement the low-energy display mode, then the mode control 144 implements a mode switch, by instructing or otherwise causing a change to the configuration or setting of the rendering engine 120 for the service application 100, such that the display output of the service application 100 does not match the configuration or setting used by the operating system 12. Alternatively, the service application 100 can communicate a change to the display setting 115 or configuration used by the operating system 12, so that the display output of the mobile computing device 10 is changed upon the determination of the service application 100.

As described with some examples, the service application 100 may operate to receive communications containing network service information 101 from a network computer system 150. The communications from the network computer system 150 can trigger the service application 100 to generate content based on information contained in the communications. For example, the network service information 101 from the network computer system 150 can include opportunities for the user, and the service application 100 can generate one or more notifications or alerts for each of the opportunities that are received from the network computer system 150. In some implementations, the service application 100 may enable a user of the mobile computing device 10 to participate in a network service provided by the network computer system 150 as a service provider. In such context, the service application can receive time-limited communications that provide opportunities for the user of the service application. For example, the network computer system can periodically match the service provider with one or more job orders for transport-related services. After matching the service provider with job orders, the network computer system 150 can transmit network service information 101 that identifies the matched job orders to the service provider. In this way, the service provider may receive periodic transmissions from the network computer system 150, where each job order is associated with a time interval that defines a duration in which the opportunity represented by the job order is available to the service provider. The time interval can be defined by a condition (e.g., passage of time until the next interval when matching and transmission of job orders is performed by the network computer system 150) or event (e.g., an opportunity represented by matched job order is no longer available, because the job order was canceled or another user accepted the job order).

In step 230, upon the service application 100 being triggered to display a content that is based on a communication received from a network service, the service application operates to cause a mode switch in which a regular (or high-energy) display mode is implemented on the mobile computing device, in place of the low-energy display mode. As described, in the regular or high-energy display mode, the mobile computing device 10 device expends more energy than the low-energy display mode. As a result of the mode switch, an example provides that a display output of the mobile computing device 10 can be brightened. As an addition or variation, as a result of the mode switch, the display output can be made less dark, subjected to a higher refresh rate, and/or colorized.

In step 240, the service application operates to automatically cause a second mode switch in which a third display mode is implemented in place of the second display mode, coinciding with the service application 100 ceasing to display the content of the communication. In examples, the third display mode expends less energy than the second display mode. Further, the third display mode can be the same as the first display mode. Alternatively, the third display mode can expend more or less energy than the first display mode, depending on implementation. In this way, the second display mode (e.g., the regular display mode) is implemented for a duration that is based on or substantially coincides with, the notification(s) or alert(s) being displayed on the user device. Thus, for example, the display output of the mobile computing device 10 may brighten for a duration that coincides with notifications or alerts being displayed by the service application 100, such that the display output returns to the low-energy display mode at or about the same time as when the notifications or alerts cease to be displayed.

With reference to FIG. 3, in step 310, network computer system 150 may receive a request from the computing device of a user to initiate a session, where the user participates as a service provider during the session. The request may coincide with, for example, the user opening the service application 100, and the service application performing a series of communications, via network interface 110, to authenticate the user and provide the network computer system 150 with a current location of the user.

Step 320 provides that in response to receiving the request, the network computer system enables the mobile computing device 10 to implement a low-energy display mode if the battery state of the mobile computing device 10 meets one or more conditions. As described with other examples, the one or more conditions can be defined based on a determination of the battery state of the mobile computing device 10.

In step 330, a time limited communication is transmitted to the mobile computing device 10, where the communication causes the service application 100 to display corresponding content for a given time interval. For example, the network computer system 150 can transmit a set of communications that identifies a time-limited opportunity. The instructions or logic cause the service application 100 to generate one or more notifications or alerts that are displayed for a given time interval, after which the service application 100 ceases to display the notification or alerts. Subsequently, the network computer system 150 can generate another set of communications that refresh the information contained in the prior set of communications. For example, the communications from the network computer system 150 can define opportunities for the service provider, where the opportunities are based on a location of the service provider, a number of available opportunities in a region that is proximate to the location of the service provider, and/or a number of other service providers that are operating in that region. The network computer system 150 can repeatedly refresh what opportunities are matched to the service provider, to reflect the number of service providers, the number of opportunities and/or the current location of the service provider. Prior to receiving a set of communications from the network computer system 150, the service application 100 may implement a timer, or respond to logic communicated from the network computer system 150, to cease displaying the notifications or alerts.

In step 332, examples provide that the communication from the network computer system 150 causes the mobile computing device 10 to switch from the low-energy display mode to a regular or high-energy display mode, at least for a duration that coincides with the corresponding notification or alert being rendered. After the duration, the mobile computing device 10 switches back to the low-energy display mode. In this way, the time-limited communication from the network computer system 150 causes the display output to be implemented in the regular or high-energy display mode for purpose of displaying the time-limited notification or alert.

### Hardware System

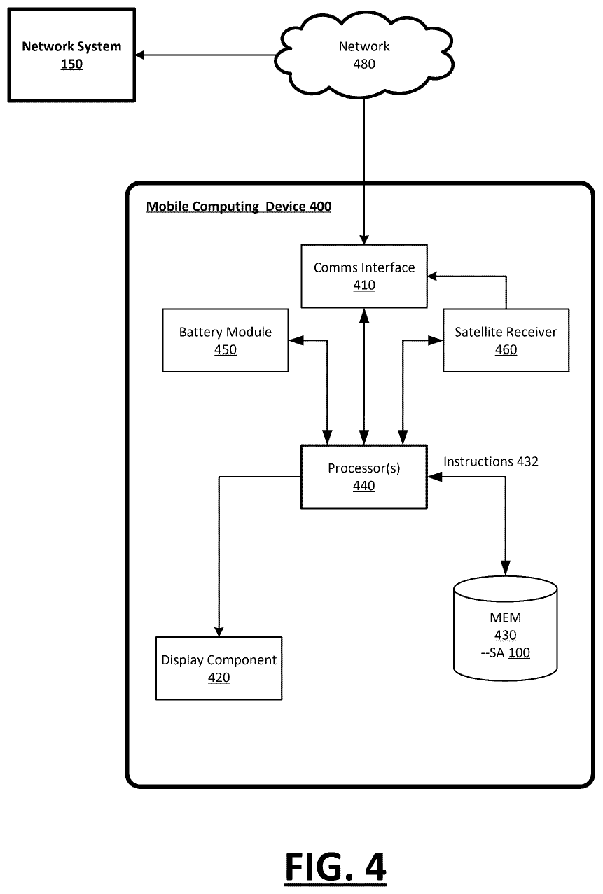

FIG. 4 is a block diagram illustrating an example user device on which a service application can be operated, according to one or more embodiments. The mobile computing device 400 can correspond to mobile computing device 10 of an example of FIG. 1. The mobile computing device 400 can correspond to, for example, a smartphone, feature phone or tablet.

In examples, the mobile computing device 400 can include a communication interface 410, a display component 420, memory resources 430, one or more processors, a battery module 450 and a satellite receiver. The communication interface 410 can communicate over one or more networks 480 with external entities such as the network computer system 150 (FIG. 1), using any number of communication protocols. The satellite receiver 460 can communicate with a satellite navigation system to obtain a current location of the mobile computing device 400. The memory resources 430 include memory for storing an operating system, as well as memory for storing the service application 100. The service application 100 can be stored in, for example, a random access memory (RAM) resource and include programs and/or instructions executable by the one or more processors 440, to, for example, communicate with the network computer system 150, receive communications from the network computer system 150, and render content on the display component 420 based on the communications. The instructions can also be executed by the processor 440 to generate navigation content for the display component 420, where the navigation content is generated in conjunction with location information of the satellite receiver 460. The instructions can include display mode controller instructions 432, which control implementation of one or more low-energy display modes on a display output of the display component 420.

The battery module 450 can include a set of batteries, along with hardware, firmware, and other logic to regulate charging and use of the batteries. The battery module 450 provides a power buss that powers the components of the mobile computing device 400. As described with examples, the processor 440 executes the instructions 432 (e.g., as part of the service application 100) to determine the battery state of the device, and further to control the use of one or more low-energy display modes when the service application 100 is being utilized. Further, the processor 440 can execute instructions 432 to implement a method such as described with an example of FIG. 2.

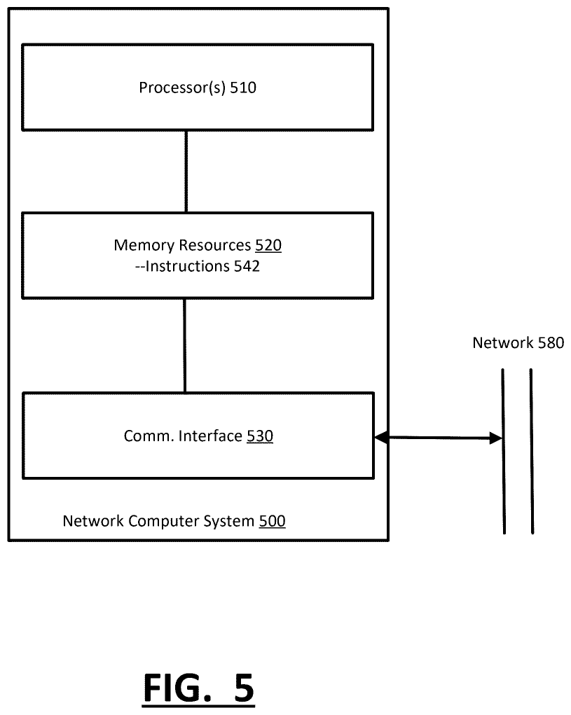

FIG. 5 is a block diagram that illustrates a network computer system, according to one or more embodiments. A network computer system 150, such as described with an example of FIG. 1 and FIG. 3, can be implemented using a network computer system 500 of FIG. 5.

In one implementation, the network computer system 500 includes one or more processors 510, memory resources 520, and a communication interface 530. The computer system 500 includes at least one processor 510 for processing information. The memory resources 520 may include a random access memory (RAM) or other dynamic storage device, for storing information and instructions to be executed by the processor(s) 510. The memory resources 520 also may be used for storing temporary variables or other intermediate information during execution of instructions to be executed by the processor(s) 510. The computer system 500 may also include other forms of memory resources, such as static storage devices for storing static information and instructions for the processor 510. The memory resources 520 can store information and instructions, including instructions 542 for implementing a network service, and further for implementing a method such as described with an example of FIG. 3.

The communication interface 530 can enable the computer system 500 to communicate with one or more networks 580 (e.g., cellular network) through use of the network link (wireless or wireline). Using the network link, the computer system 500 can communicate with one or more other computing devices and/or one or more other servers or data centers. In some variations, the computer system 500 can receive service requests from requester devices via the network link 580. Additionally, the computer system 500 can transmit communications to mobile computing devices of users, where the communications include opportunities for the service provider to provide a transport service for one or more of the service requests.

Examples described herein are related to the use of the computer system 500 for implementing the techniques described herein. According to one embodiment, those techniques are performed by the computer system 500 in response to the processor 510 executing one or more sequences of one or more instructions contained in the memory resource 520. Such instructions may be read into a main memory from another machine-readable medium, such as a storage device. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### CONCLUSION

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A non-transitory computer-readable medium that stores instructions, which when executed by one or more processors of a computing device, cause the computing device to implement operations that comprise:
determining a battery state of the computing device when a service application is operating on the computing device;
based on the determined battery state, causing a first display mode to be implemented on the computing device;
upon the service application being triggered to display a content that is based on a communication received from a network service, causing a first mode switch in which a second display mode is implemented on the computing device, the second display mode causing the computing device to expend more energy than the first display mode; and
automatically causing a second mode switch in which a third display mode is implemented, the third display mode causing the computing device to expend less energy than the second display mode, the third display mode coinciding with the service application ceasing to display the content of the communication.

2. The non-transitory computer-readable medium of claim 1, wherein determining the battery state of the computing device includes determining whether the service application is being executed on the computing device in a dark mode.

3. The non-transitory computer-readable medium of claim 1, wherein determining the battery state of the computing device includes determining at least one of (i) a current power level of a battery of the computing device, or (ii) whether the battery is currently being charged or is connected to an external power source.

4. The non-transitory computer-readable medium of claim 1, wherein determining the battery state of the computing device includes determining that a function that the computing device would otherwise perform is being performed by a second computing device of a vehicle operated by a service provider.

5. The non-transitory computer-readable medium of claim 1, wherein the second display mode is based on a configuration or display setting of an operating system of the computing device.

6. The non-transitory computer-readable medium of claim 1, wherein the operations include:
receiving, by the service application over one or more networks, the communication, the communication identifying one or more service request jobs; and
wherein the service application implements the second display mode to display the content, based on the one or more service request jobs, for a time interval that extends until an event or condition is detected.

7. The non-transitory computer-readable medium of claim 6, wherein upon the event or condition being detected, the one or more service request jobs ceases to display the one or more service request jobs and implements the third display mode.

8. The non-transitory computer-readable medium of claim 1, wherein each of the first display mode and the third display mode has a brightness level that is lower than a brightness level of the second display mode.

9. The non-transitory computer-readable medium of claim 1, wherein the first display mode and the third display mode have a brightness level that is about the same.

10. The non-transitory computer-readable medium of claim 1, wherein each of the first display mode, the second display mode, and the third display mode are characterized by a brightness level.

11. A mobile computing device comprising:
one or more processors;
a memory to store a set of instructions;
wherein the one or more processors execute the set of instructions to perform operations that include:
determining a battery state of the mobile computing device when a service application is operating on the computing device;
based on the determined battery state, causing a first display mode to be implemented on the mobile computing device;
upon the service application being triggered to display a content that is based on a communication received from a network service, causing a first mode switch in which a second display mode is implemented on the mobile computing device, the second display mode causing the mobile computing device to expend more energy than the first display mode; and
automatically causing a second mode switch in which a third display mode is implemented, the third display mode causing the mobile computing device to expend less energy than the first display mode, the third display mode coinciding with the service application ceasing to display the content of the communication.

12. The mobile computing device of claim 11, wherein determining the battery state includes determining whether the service application is being executed on the mobile computing device in a dark mode.

13. The mobile computing device of claim 11, wherein determining the battery state includes determining at least one of (i) a current power level of a battery of the mobile computing device, and/or (ii) whether the battery is currently being charged or is connected to an external power source.

14. The mobile computing device of claim 11, wherein determining the battery state of the mobile computing device includes determining that a function that the mobile computing device would otherwise perform is being performed by another computing device.

15. The mobile computing device of claim 11, wherein the second display mode is based on a configuration or display setting of an operating system of the mobile computing device.

16. The mobile computing device of claim 11, wherein the operations include:
receiving, by the service application, the communication, the communication identifying one or more service request jobs; and
wherein the service application implements the second display mode to display the one or more service request jobs for a time interval that extends until an event or condition is detected.

17. The mobile computing device of claim 16, wherein upon the event or condition being detected, the one or more service request jobs ceases to display the one or more service request jobs and implements the third display mode.

18. The mobile computing device of claim 11, wherein each of the first display mode, the second display mode, and the third display mode are characterized by a brightness level, and wherein each of the first display mode and the third display mode is dimmer than the second display mode.

19. The mobile computing device of claim 11, wherein the first display mode and the third display mode are about the same.

20. A computer-implemented method for operating a mobile computing device, comprising:
determining a battery state of the computing device when a service application is operating on the computing device;
based on the determined battery state, causing a first display mode to be implemented on the mobile computing device;
upon the service application being triggered to display a content that is based on a communication received from a network service, causing a first mode switch in which a second display mode is implemented on the mobile computing device, the second display mode causing the mobile computing device to expend more energy than the first display mode; and
automatically causing a second mode switch in which a third display mode is implemented, the third display mode causing the mobile computing device to expend less energy than the first display mode, the third display mode coinciding with the service application ceasing to display the content of the communication.
